(19) United States
(12) Patent Application Publication
(10) Pub. No.: US 2019/0225090 A1
(43) Pub. Date: Jul. 25, 2019

(54) SYSTEM FOR POWERING AN ELECTRIC VEHICLE AND METHOD

(71) Applicant: Jonathan Prieto, San Pedro, CA (US)

(72) Inventor: Jonathan Prieto, San Pedro, CA (US)

(21) Appl. No.: 15/880,414

(22) Filed: Jan. 25, 2018

(51) Int. Cl. B60L 11/18; B60L 8/00

(52) U.S. Cl. CPC B60L 11/1812; B60L 8/003; B60L 8/006

(57) ABSTRACT

A system for powering an electric-vehicle including a first-electrical assembly including at least one battery assembly, a first-power-inverter, at least one motor, at least one alternator, at least one drive-motor, a solar-array, a battery-charger, and a direct current wind-turbine. The at least one battery assembly includes a direct current to output a direct current power supply. The first-power-inverter receives the direct current power supply to convert the direct current to an alternating current. The at least one motor configured to receive the alternating current power supply to produce rotative mechanical energy. The at least one alternator is mechanically coupleable to the at least one motor configured to convert rotative mechanical energy to direct current electrical energy; the at least one alternators configured to power the at least one battery via the direct current electrical energy. The drive-motor is electrically coupleable to the alternator and configured to propel the electric-vehicle.

### CROSS-REFERENCE TO RELATED APPLICATION(S)

The present application is related to and claims priority to U.S. Provisional Patent Application No. 64/450,473 filed Jan. 25, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of electrical generator or motor structures of existing art and more specifically relates to motor-generator sets.

### RELATED ART

Cars and other automobiles are common means for individuals to transport themselves between destinations. The most widely used automobiles operate using an internal combustion engine which requires the burning of fossil fuels. Emissions and exhaust from cars, trucks, and other vehicles not only pollute the air but also cause adverse health effects. Car exhaust is even toxic at ground level. Without intervention, automotive engines can increase environmental footprint putting our future in jeopardy.

One attempted solution to the internal combustion engine is an electric vehicle. An electric vehicle uses one or more electric motors for motion. An electric vehicle may be powered through a collector system by electricity from off-vehicle sources, or may be self-contained with a battery, or solar panels.

In the 21st century, electric vehicles saw resurgence due to technological developments and an increased focus on renewable energy. Government incentives to increase adoptions were introduced, including in the United States and the European Union. One such limitation with most electric vehicles is that they have a limited range based on the charging capacity of the batteries. Therefore, a suitable solution is desired.

U.S. Pub. No. 2006/0232068 to Abram Ellison relates to perpetual motion energy. The described perpetual motion energy can be used to replace oil, gas, and coal as major sources of energy, by replacing them with perpetual motion energy. One of the many uses for perpetual motion energy is illustrated in an electrical circuit for electric for electric cars or vehicles, showing how: two or more batteries transmit electric current and amps to an Electric Wire Distributor Connector; the distributor sends electric current and amps to an electric motor; the electric motor provides power, and also rotates a generator; the generator charges two or more batteries; the distributor also recharges the batteries by recycling one hundred percent or more energy back to the batteries to produce perpetual motion energy. The batteries do not have to be recharged by any other source. Furthermore, the same circuitry can be applied to in-house electric generators to supply electricity and heat energy to residential and commercial buildings. The use of perpetual motion energy can provide perpetual, efficient, reliable, clean and economical energy through the use of batteries as a power source.

### SUMMARY OF THE INVENTION

In view of the foregoing disadvantages inherent in the known motor-generator sets art, the present disclosure provides a novel system for powering an electric vehicle. The general purpose of the present disclosure, which will be described subsequently in greater detail, is to provide an efficient and effective system for powering an electric vehicle.

A system for powering an electric-vehicle is disclosed herein. The system for powering an electric-vehicle includes a first-electrical assembly. The first electrical-assembly includes at least one battery assembly, a first-power-inverter, at least one motor, at least one alternator, at least one drive-motor, a solar-array, a battery-charger, and a direct current wind-turbine.

The at least one battery assembly includes a direct current configured to output a direct current power supply. The first-power-inverter is configured to receive the direct current power supply from the at least one battery assembly, and further configured to convert the direct current to an alternating current; the alternating current configured to output an alternating current power supply.

The at least one motor is configured to receive the alternating current power supply from the first-power-inverter to produce rotative mechanical energy. The at least one alternator is mechanically coupleable to the at least one motor and configured to convert the rotative mechanical energy to direct current electrical energy; the at least one alternators are further configured to power the at least one battery assembly via the direct current electrical energy.

The drive-motor is electrically coupleable to the at least one alternator; the at least one drive-motor configured to propel the electric-vehicle. The solar-array and a battery-charger are electrically coupled and configured to provide a direct current to recharge the at least one battery assembly during use. Also, the direct current wind-turbine is configured to provide a direct current to recharge the at least one battery assembly when the electric-vehicle is in motion by harnessing wind power. Further, the battery-charger is further configured to receive a 120 volt outside electrical source configured to recharge the at least one battery assembly. The present invention is not perpetual motion; rather outside electrical sources may be used to provide energy for the system, as disclosed herein. The first-power-inverter, the at least one motor and the at least one alternator are configured in series in electrical-communication to provide an electrical-loop to propel the electric-vehicle by powering the at least one drive-motor to motively-power at least one wheel.

According to another embodiment, a method of use for a system for powering an electric-vehicle is also disclosed herein. The method of use for a system for powering an electric-vehicle includes a first step, providing a system for powering an electric-vehicle; a second step, providing direct current electricity from a battery assembly to a power-inverter such that the power-inverter converts the direct current electricity to alternating current electricity; a third step, turning a motor with the alternating current electricity such that the motor provides rotative energy to an alternator such that the alternator coverts the rotative energy to direct current electricity; a fourth step, providing the direct current to a drive-motor of a vehicle and the battery assembly; a fifth step, charging the battery assembly via a solar panel; and a sixth step, charging the at least one battery assembly via the wind-turbine.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a system for powering an electric vehicle, constructed and operative according to the teachings of the present disclosure.

FIG. 1 is a perspective view of the system for powering an electric-vehicle during an ‘in-use’ condition, according to an embodiment of the disclosure.

FIG. 2 is a side view of the system for powering an electric-vehicle of FIG. 1, according to an embodiment of the present disclosure.

FIG. 3 is a schematic view of the system for powering an electric-vehicle of FIG. 1, according to an embodiment of the present disclosure.

FIG. 4 is a schematic view of the system for powering an electric-vehicle of FIG. 1, according to an embodiment of the present disclosure.

FIG. 5 is a flow diagram illustrating a method of use for the system for powering an electric-vehicle, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to motor-generator sets and more particularly to a system for powering an electric vehicle as used to improve the efficiency and longevity of an electric vehicle to operate by providing a system that has multiple means for efficiently charging one or more batteries of an electric vehicle.

Generally, systems for powering electric vehicles decrease dependency on fossil fuels through an electrical power-generation system for an electric vehicle. This innovative system can include a housing with a steel frame, soundproofing materials, motor connectors, an electricity discharger, one or more 12-volt or 24-volt alternators (grouped together or staggered in a line), once or more DC to AC inverters, one or more AC motors, one or more batteries, solar panels, wind fins (if aircraft), and a trickle charger.

Alternators can be grouped together or staggered in a line, and the motors can be placed diagonally from each other or grouped to provide a strong central pull, depending on the size of the engine. Additionally, the solar panels can be placed on the hood or roof of the vehicle.

In use, the motor connectors can create an electrical loop, which can power the electric-generating motor and create excess electrical power. The electricity discharger can be used to transfer the excess electrical power to other sources, like backup generators.

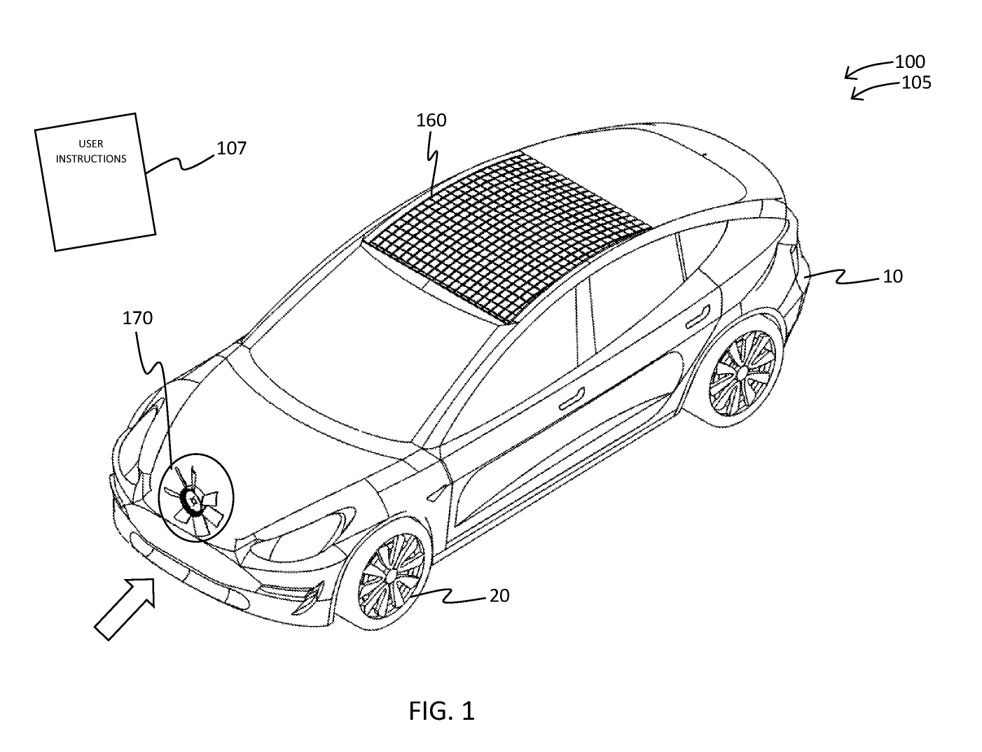

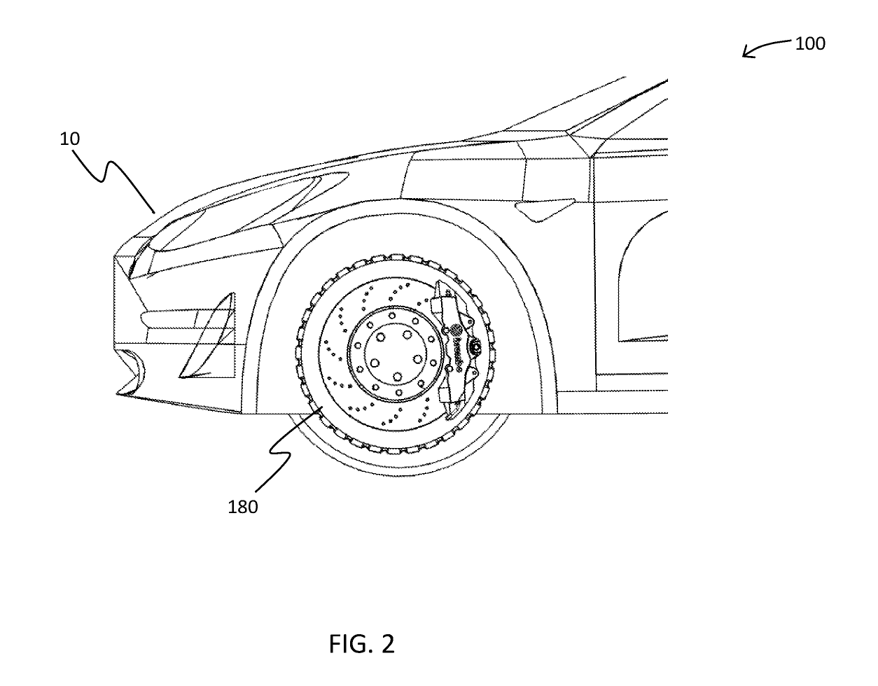

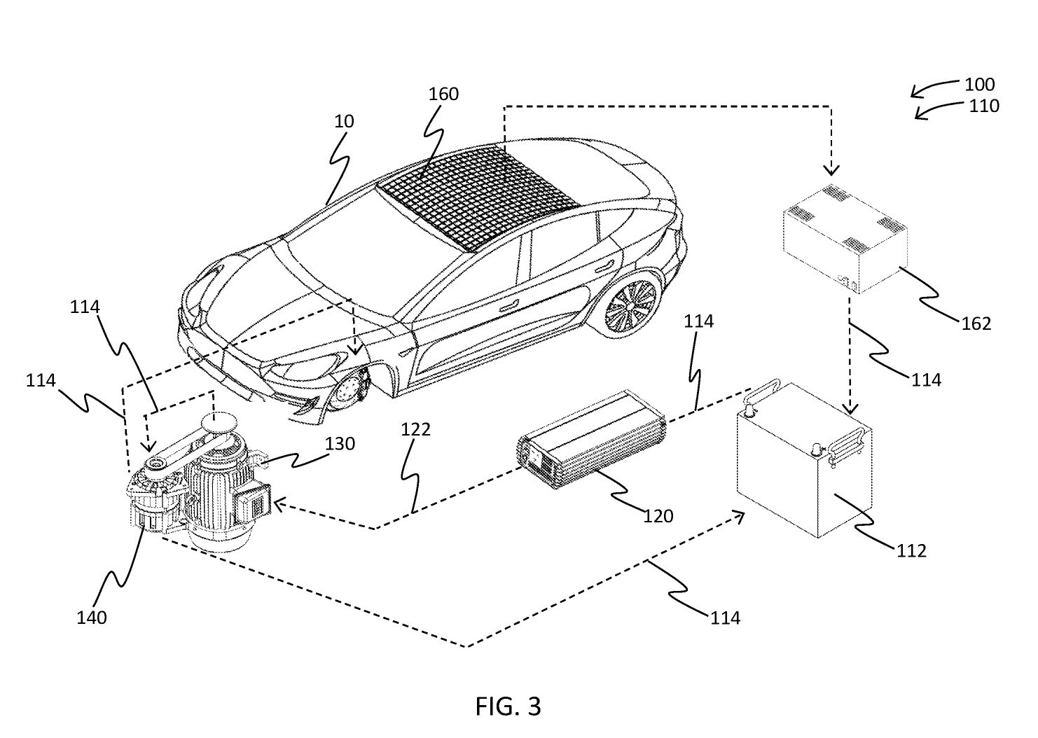

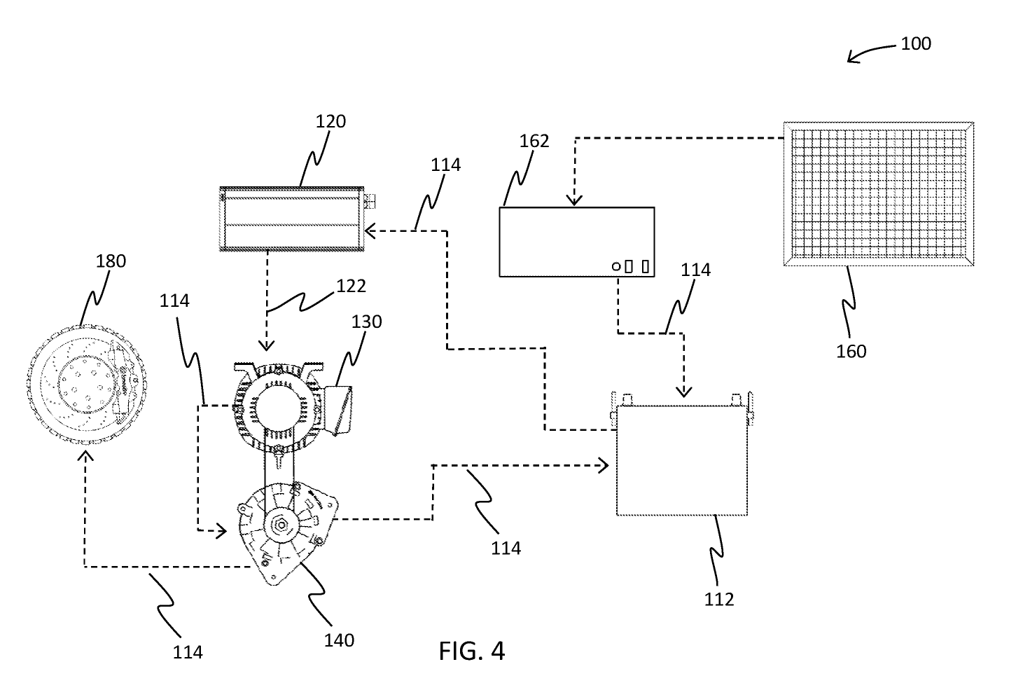

Referring now more specifically to the drawings by numerals of reference, there is shown in FIGS. 1-4, various views of a system for powering an electric vehicle 100.

FIG. 1 shows a system for powering an electric vehicle 100 during an ‘in-use’ condition 50, according to an embodiment of the present disclosure. Here, the system for powering an electric vehicle 100 may be beneficial for use by a user to charge at least one battery and provide electricity to drive electric-vehicle 10. As illustrated, the system for powering an electric vehicle 100 may include first-electrical assembly 110. First-electrical assembly 110 may include at least one battery assembly 112, first-power-inverter 120, at least one motor 130, at least one alternator 140, and at least one drive-motor 150.

According to one embodiment, the system for powering an electric vehicle 100 may be arranged as a kit 105. In particular, the system for powering an electric vehicle 100 may further include a set of instructions 107. The instructions 107 may detail functional relationships in relation to the structure of the system for powering an electric vehicle 100 such that the system for powering an electric vehicle 100 can be used, maintained, or the like, in a preferred manner. The present invention may be retro-fit to an existing vehicle or be offered OEM.

FIGS. 1-4 show the system for powering an electric vehicle 100 of FIG. 1, according to an embodiment of the present disclosure. As above, system for powering an electric vehicle 100 may include first-electrical assembly 110. Embodiments of first-electrical assembly 110 may include at least one battery assembly 112, first-power-inverter 120, at least one motor 130, at least one alternator 140, and at least one drive-motor 150.

Battery assembly 112 may include direct current 114 configured to output direct current power supply. First-power-inverter 120 may be to receive direct current power supply from battery assembly 112, and further configured to convert direct current 114 to an alternating current 122. Alternating current 122 may be configured to output an alternating current power supply. At least one motor 130 may be configured to receive alternating current power supply from first-power-inverter 120 to produce rotative mechanical energy. At least one alternator 140 mechanically may be coupleable (e.g., belt, gear, etc.) to at least one motor 130 and configured to convert the rotative mechanical energy to direct current 114 electrical energy, and at least one alternator 140 may further be configured to power at least one battery assembly 112 via direct current 114 electrical energy.

Drive-motor 150 may be electrically coupleable to at least one alternator 140; at least one drive-motor 150 is configured to propel electric-vehicle 10 during use. At least one battery assembly 112, first-power-inverter 120, at least one motor 130 and at least one alternator 140 may be configured in series in electrical-communication to provide an electrical-loop to propel electric-vehicle 10 by powering at least one drive-motor 150 to motively-power at least one wheel for forward, or rearward movement as desired.

Embodiments may also include solar-array 160 and battery-charger 162 electrically coupled and configured to provide direct current 114 to recharge at least one battery assembly 112. Embodiments may also, and/or alternatively include direct current wind-turbine 170 configured to provide direct current 114 to recharge at least one battery assembly 112 when electric-vehicle is in motion 10.

Embodiments may include a second-battery assembly arranged electrically in parallel with first-battery assembly 110. Also, second-battery assembly may be arranged electrically in series with first-battery assembly 110. Similarly, system 100 may include second-alternator powered by at least one motor 130 and/or a third-alternator powered by rotative mechanical energy from at least one motor 130. Also, system 100 may further include two motors mechanically coupleable to at least one alternator 140.

Battery-charger 162 may be further configured to receive a 120 volt outside electrical source configured to recharge at least one battery assembly 112. Also, system 100 may include a second-electrical assembly such that system 100 is configured to propel electric-vehicle 10 by powering at least one drive-motor 150 to power at least a second wheel. Relatedly, first-electrical assembly 110 and second-electrical assembly may be in electrical communication with each other.

Currents and voltages may vary in different embodiments. As such, alternating current 122 may include a 240 volt current, a 120 volt current, or other suitable voltage. Similarly, direct current 114 of system 100 may include 300 volts, 12 volts, 24 volts, or any other suitable voltage.

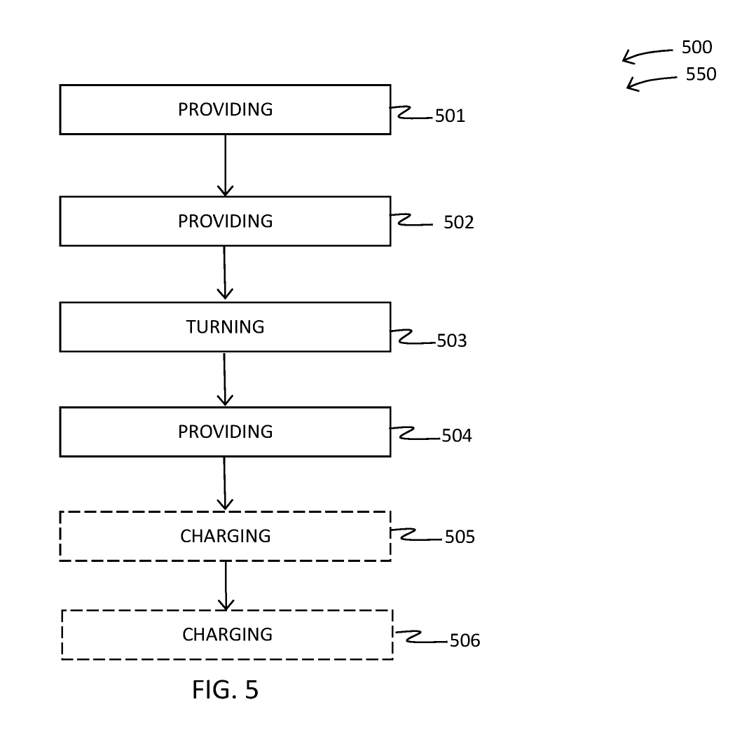

Referring now to FIG. 5, a flow diagram 550 illustrating a method of use for a system for powering an electric-vehicle 500, according to an embodiment of the present disclosure. In particular, the method for method of use for a system for powering an electric-vehicle 500 may include one or more components or features of system for powering an electric-vehicle 100 as described above. As illustrated, the method for method of use for a system for powering an electric-vehicle 500 may include the steps of: step one 501, providing a system for powering an electric-vehicle; step two 502, providing direct current 114 electricity from a battery assembly 112 to a power-inverter 120 such that power-inverter 120 converts direct current 114 electricity to alternating current electricity 122; step three 503, turning motor 130 with alternating current 122 electricity such that motor 130 provides rotative energy to alternator 140 such that alternator 140 coverts rotative energy to direct current electricity 114; step four 504, providing direct current 114 to a drive-motor 150 of electric-vehicle 10 and battery assembly 112; step five 505, charging battery assembly 112 via solar-array 160; and step six 506, charging at least one battery assembly 112 via wind-turbine 170.

It should be noted that step five 505 and step six 506 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for method of use for a system for powering an electric-vehicle [NOTE: e.g., different step orders within above-mentioned list, elimination or addition of certain steps, including or excluding certain maintenance steps, etc.], are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for powering an electric-vehicle, the system comprising:
a first-electrical assembly, said first-electrical assembly including;
at least one battery assembly, said at least one battery assembly including a direct current configured to output a direct current power supply;
a first-power-inverter, said first-power-inverter configured to receive the direct current power supply from said at least one battery assembly, and further configured to convert said direct current to an alternating current, the alternating current configured to output an alternating current power supply;
at least one motor, said at least one motor configured to receive said alternating current power supply from said first-power-inverter to produce rotative mechanical energy;
at least one alternator, said at least one alternator mechanically coupleable to said at least one motor and configured to convert said rotative mechanical energy to direct current electrical energy, said at least one alternators further configured to power the at least one battery assembly via the direct current electrical energy;
at least one drive-motor, said drive-motor electrically coupleable to said at least one alternator, said at least one drive-motor configured to propel said electric-vehicle; and
wherein said at least one battery assembly, said first-power-inverter, said at least one motor and said at least one alternator are configured in series in electrical-communication to provide an electrical-loop to propel said electric-vehicle by powering said at least one drive-motor to motively-power at least one wheel.

2. The system of claim 1, further including a solar-array and a battery-charger electrically coupled and configured to provide a direct current to recharge said at least one battery assembly.

3. The system of claim 1, further including a direct current wind-turbine configured to provide a direct current to recharge said at least one battery assembly when said electric-vehicle is in motion.

4. The system of claim 1, further including a second-battery assembly arranged electrically in parallel with said first-battery assembly.

5. The system of claim 1, further including a second-battery assembly arranged electrically in series with said first-battery assembly.

6. The system of claim 1, further including a second-alternator powered by said at least one motor.

7. The system of claim 1, further including a third-alternator powered by said rotative mechanical energy from said at least one motor.

8. The system of claim 1, further including two said motors mechanically coupleable to said at least one alternator.

9. The system of claim 1, wherein said battery-charger is further configured to receive a 120 volt outside electrical source configured to recharge said at least one battery assembly.

10. The system of claim 1, wherein said system includes a second-electrical assembly such that said system is configured to propel said electric-vehicle by powering said at least one drive-motor to power at least a second wheel.

11. The system of claim 10, wherein said first-electrical assembly and said second-electrical assembly are in electrical communication with each other.

12. The system of claim 1, wherein said alternating current includes a 240 volt current.

13. The system of claim 1, wherein said alternating current includes a 120 volt current.

14. The system of claim 1, wherein said direct current of said system includes 300 volts.

15. The system of claim 1, wherein said direct current of said system includes 12 volts.

16. The system of claim 1, wherein said direct current of said system includes 24 volts.

17. A system for powering an electric-vehicle, the system comprising:
a first-electrical assembly, said first-electrical assembly including;
at least one battery assembly, said at least one battery assembly including a direct current configured to output a direct current power supply;
a first-power-inverter, said first-power-inverter configured to receive the direct current power supply from said at least one battery assembly, and further configured to convert said direct current to an alternating current, the alternating current configured to output an alternating current power supply;
at least one motor, said at least one motor configured to receive said alternating current power supply from said first-power-inverter to produce rotative mechanical energy;
at least one alternator, said at least one alternator mechanically coupleable to said at least one motor and configured to convert said rotative mechanical energy to direct current electrical energy, said at least one alternators further configured to power the at least one battery assembly via the direct current electrical energy;
at least one drive-motor, said drive-motor electrically coupleable to said at least one alternator, said at least one drive-motor configured to propel said electric-vehicle;
a solar-array and a battery-charger electrically coupled and configured to provide a direct current to recharge said at least one battery assembly;
a direct current wind-turbine configured to provide a direct current to recharge said at least one battery assembly when said electric-vehicle is in motion;
wherein said battery-charger is further configured to receive a 120 volt outside electrical source configured to recharge said at least one battery assembly; and
wherein said at least one battery assembly, said first-power-inverter, said at least one motor and said at least one alternator are configured in series in electrical-communication to provide an electrical-loop to propel said electric-vehicle by powering said at least one drive-motor to motively-power at least one wheel.

18. The system of claim 17, further comprising set of instructions; and
wherein the system is arranged as a kit.

19. A method of use for a system for powering an electric-vehicle, the method comprising the steps of:
providing a system for powering an electric-vehicle;
providing direct current electricity from a battery assembly to a power-inverter such that said power-inverter converts said direct current electricity to alternating current electricity;
turning a motor with said alternating current electricity such that said motor provides rotative energy to an alternator such that said alternator coverts said rotative energy to direct current electricity; and
providing said direct current to a drive-motor of a vehicle and said battery assembly.

20. The method of claim 19, further comprising the steps of
charging said battery via a solar panel; and
charging said at least one battery assembly via a wind-turbine.
